(19) United States
(12) Patent Application Publication
(10) Pub. No.: US 2014/0223502 A1
(43) Pub. Date: Aug. 7, 2014

(54) Method of Operating an IP Client

(71) Applicant: GENERAL INSTRUMENT CORPORATION, Horsham, PA (US)

(72) Inventors: Thomas J. Doblmaier, North Wales, PA (US); Steven C. Cherry, Dresher, PA (US); Joseph M. Derham, Coopersburg, PA (US); Laurie A. Kane, Lansdale, PA (US)

(73) Assignee: GENERAL INSTRUMENT CORPORATION, Horsham, PA (US)

(21) Appl. No.: 13/760,302

(22) Filed: Feb. 6, 2013

(51) Int. Cl. H04N 21/258

(52) U.S. Cl. CPC H04N 21/25866
USPC 725/93

(57) ABSTRACT

An IP client device that is connected to a display device for presentation of AV content pulls AV content for a user-selected service from a server and presents the AV content to the user. Concurrently, the IP client device pulls a selected version of AV content for an additional service from a server that hosts multiple versions of the AV content for the additional service, the multiple versions providing the AV content for the additional service at different bit rates, and temporarily storing the selected version of the AV content for the additional service in a memory. In response to a request from the user for presentation of the AV content for the additional service, the IP client device reads the selected version of the AV content for the additional service from the memory and presents the AV content for the additional service to the user.

### BACKGROUND

The subject matter of this application relates to a method of operating an IP client device.

For many years programming viewable on a TV appliance has been broadcast by employing an analog video signal to modulate a radio frequency carrier and propagating the modulated RF carrier over a cable network. The analog video signals for different broadcast TV channels (commonly associated with channel names, such an NBC, CBS and FOX) are impressed on carriers at different frequencies. A receiver in the subscriber premises responds to a channel change request by selecting the carrier frequency of the channel that is desired for screening. The receiver may be integrated in the TV appliance or it may be included in a separate device, such as a set-top box (STB).

Television programming and other multimedia content (MM content), including audio, video, graphics, text and data, may also be distributed using digital cable technology. In this case, the content for a given service (corresponding to a channel of the analog broadcast television domain) may be received at the cable network headend in the form of one or more packetized elementary streams that have been encoded in accordance with appropriate compression standards, such as the video compression standard that is commonly referred to as H.264/AVC. The cable network operator may distribute several services by organizing the payloads of the corresponding packetized elementary streams in transport stream packets that are delivered over the cable network physical infrastructure using one or more MPEG-2 systems transport streams. A cable network operator may also distribute digital audio/video (AV) content over the cable network physical infrastructure using internet protocol TV (IPTV).

In an implementation of IPTV, AV content for live TV channels is encoded and encrypted and is made available through an IP server, a delivery network (such as the cable network physical infrastructure) and a home gateway to an IP client running on a computing device in a TV appliance or an STB. In response to a channel change request, the IP client leaves its current IP session, joins the IP session for the selected service, receives the encoded and encrypted AV content for the selected service, decrypts and decodes the content, and provides the content for presentation by the TV appliance. This lengthy sequence of operations may cause some viewers to conclude that the channel change takes an unreasonably long time.

### SUMMARY

In accordance with a first aspect of the subject matter disclosed herein there is provided a method of operating an IP client device that is connected to a display device for presentation of AV content, the method comprising pulling AV content for a user-selected service from a server and presenting the AV content to the user, concurrently pulling a selected version of AV content for at least one additional service from a server that hosts multiple versions of the AV content for the additional service, the multiple versions providing the AV content for the additional service at different bit rates, and temporarily storing the selected version of the AV content for the additional service in a memory, and in response to a request from the user for presentation of the AV content for the additional service, reading the selected version of the AV content for the additional service from the memory and presenting the AV content for the additional service to the user.

In accordance with a second aspect of the subject matter disclosed herein there is provided a method of operating an IP client device that is connected to a display device for presentation of AV content, the method comprising pulling coded AV content for a user-selected service from an adaptive bit rate server, decoding the AV content for the user-selected service, and presenting the decoded AV content to the user, concurrently pulling a selected version of coded AV content for at least one additional service from a server that hosts multiple versions of the AV content for the additional service, the multiple versions providing the AV content for the additional service at different bit rates, and temporarily storing the selected version of the coded AV content for the additional service in a memory, and in response to a request from the user for presentation of the AV content for the additional service, reading the selected version of the coded AV content for the additional service from the memory, decoding the AV content for the additional service, and presenting the decoded AV content for the additional service to the user.

### BRIEF DESCRIPTION OF THE DRAWINGS

For a better understanding of the invention, and to show how the same may be carried into effect, reference will now be made, by way of example, to the accompanying drawings, in which:

FIG. 1 is a schematic block diagram illustrating an application of adaptive bitrate streaming to IPTV,

FIG. 2 is a schematic block diagram illustrating application of adaptive bitrate streaming to a method of facilitating fast channel charge in IPTV, and

FIG. 3 is a schematic block diagram of a computing device that may be used to implement the method described with reference to FIG. 2.

### DETAILED DESCRIPTION

Using adaptive bit rate (ABR) streaming technology, several versions of the same MM content may be created and published to an IP server and thereby made available over the internet. The different versions may be considered to be of different quality levels (high, medium and low, for example) and, for a given interval of time, require different numbers of bits to encode the content. Consequently, the high quality version of the content requires that the network be able to support delivery of the content at a relatively high bit rate and that the IP client device be able to process the content at a relatively high bit rate. Correspondingly, the medium quality version requires that the network and the IP client device be able to operate at a medium bit rate, whereas the low quality version is able to deliver and process the content at a relatively low bit rate. {{It will be appreciated that factors such as network congestion and processing power of the IP client device govern the bit rate at which the content can be delivered and processed. }}

The IP client selects a version for playback depending on factors such as network congestion and the processing power of the client device. The IP client utilizes a “pull” model whereby it pulls the content in relatively small segments (e.g. of about 10 second duration) for presentation to the viewer. As conditions change dynamically, the client can dynamically change between different bit rate versions of the MM content to ensure smooth playback to the viewer.

Broadcast television content may also be delivered to IP clients through ABR streaming technology. In the case of an on demand subscription service, the content may be stored indefinitely for viewing when desired by the customer, whereas in the case of linear television (such as broadcast television), in which the program is made available at a particular time and as a particular service and the viewer decides whether to take it or leave it, the content is concurrently ingested by a transcoder, which creates multiple versions of the content at different bit rates, and the content is made available only transiently to the viewer.

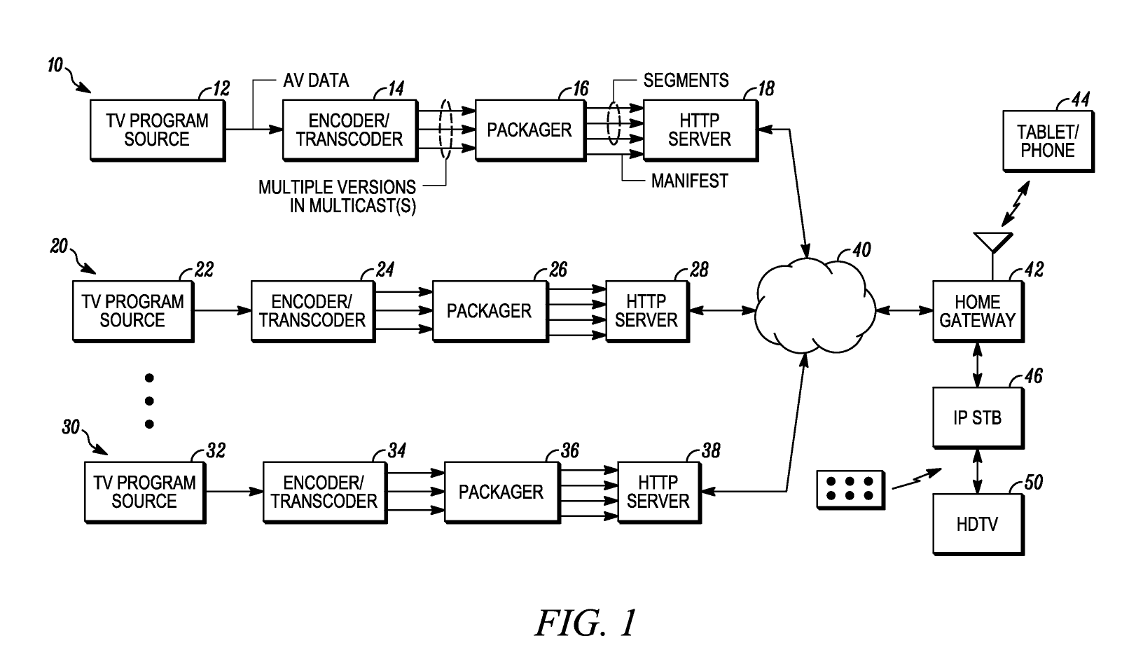

Referring to FIG. 1, an ABR streaming appliance 10 includes a TV program source 12 that delivers a signal conveying the AV content for a given service to a transcoder 14. The AV content may be provided in the form of an IP multicast carrying one or more MPEG-2 transport streams. The transcoder produces several, e.g. three, versions of the AV content encoded in accordance with appropriate audio and video compression standards. For example, the transcoder might produce a high bit rate version, a medium bit rate version, and a low bit rate version. For each version, the transcoder produces a video elementary stream and a first language audio elementary stream, and may also produce other elementary streams, such as a second language audio stream and a subtitle stream. The several streams for each version are multiplexed together to produce an MPEG single program transport stream or the several streams for the several versions may be multiplexed together to produce an MPEG multiprogram transport stream.

The transcoder outputs the three versions of the AV content in at least one IP multicast. Depending on how the elementary streams are multiplexed, the transcoder may produce three IP multicasts conveying respective single program transport streams for the three versions respectively or it may produce one IP multicast conveying one multiprogram transport stream for all three versions. The transcoder provides the multicast(s) conveying the three different versions to a packager 16, which slices the three versions of the content into segments and supplies the three sequences of segments to an HTTP server 18, which makes the three sequences available for pulling by an IP client running on a device connected to the internet. The packager also provides a manifest file (or play list), which contains metadata for the different versions that are available, including information that specifies the bit rates of the three versions.

Even though the transcoder supplies the transport stream(s) to only one receiving device (the packager 16), nevertheless it is preferred that the transport stream(s) be conveyed by an IP multicast rather than an IP unicast because the multicast is agnostic with respect to the receiving device.

FIG. 1 also shows ABR streaming appliances 20 and 30, including functional blocks 22-28 and 32-38, for processing programming content for other TV services. The HTTP servers 18, 28 and 38 are connected to the internet 40. For the sake of simplicity, the foregoing description of the ABR streaming appliance refers to only one service, but it will be appreciated by those skilled in the art that typically a single transcoder and packager will provide multiple live TV services.

At a customer premises, a home gateway 42 (including a router that is not separately shown) is connected to the internet 40. The home gateway is connected wirelessly to a tablet or phone 44. A wired connection is provided between the home gateway 42 and an STB 46, which is connected to a TV appliance 50.

In order to present the program content provided by the TV program service 12 to the customer, an IP client running on a computing device, such as the STB 46, sends an appropriate HTTP command, such as the HTTP Get command, to the server 18, signifying that the IP client wishes to acquire the IP data for a service from the server 18. It will be appreciated that the IP client may also need to abandon a current session that is running, for example, on the server 28. The IP client pulls the manifest file from the server 18. Having regard to factors such as network congestion and CPU utilization, the IP client running on the STB 46 uses the information in the manifest file to select one of the three versions of the AV content and pulls the IP packets for that version from the server 18.

The IP client running on the STB 46 receives the IP packets for the selected version of the programming content and decrypts and decodes the packets to produce an AV signal for driving the TV appliance 50 and presenting the AV content to the viewer.

Suppose, for example, that initially the IP client requested the high bit rate version of the content but that subsequently network congestion increased. The IP client responds to the increase in network congestion by pulling the medium or low bit rate version. In this manner, the customer is able to watch the program with a reduced likelihood of objectionable artifacts, such as dropped frames, in the display.

It will be understood by those skilled in the art that the packager 16 slices the different versions of the AV content each into a sequence of segments. Each segment is typically from two to ten seconds in duration. The start and end of a given segment in one version is aligned in time with the start and end of a corresponding segment in each other version. Each segment has a header that includes a number that identifies the position of that segment in its sequence of segments and corresponding segments in the different versions have the same identifying number. Accordingly, when switching from one version to another the IP client pulls the segment having the next number in the sequence and there is no discontinuity in evolution of the content that is presented: the only change is in the bit rate with which that content is presented. A difference in bit rate may manifest itself as a change in resolution of video material, but the video material evolves smoothly, without a jerky display.

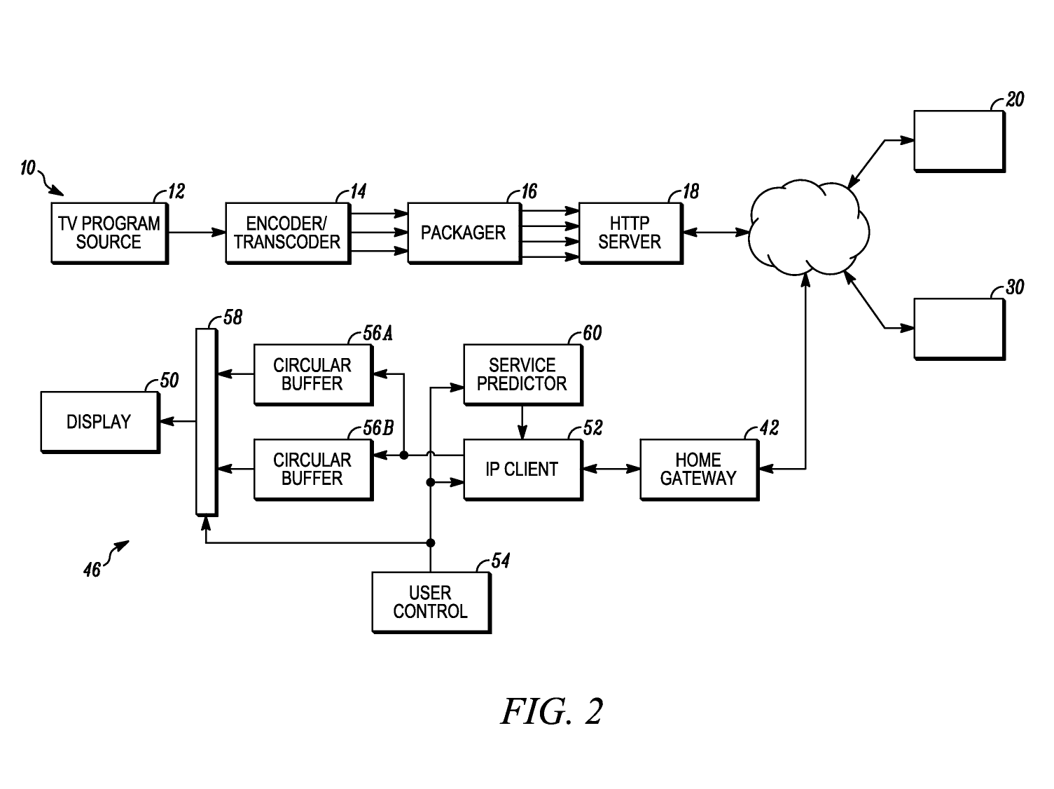

Referring to FIG. 2, the STB 46 includes an IP client 52 that is responsive to a channel change request provided through a user control 54 to abandon its current IP session and transmit an HTTP Get command to an HTTP server from which the service identified by the channel change request is available. Let us assume that the HTTP Get command is transmitted to the server 18 of the ABR streaming appliance 10 and pulls the manifest file for the identified service from the server 18.

Having transmitted the HTTP Get command, the IP client 52 receives the manifest file produced by the packager 16. The IP client selects a version of the selected service and transmits HTTP Get commands to pull down the IP packets conveying the transport stream packets. As discussed above, the IP packets are received in segments corresponding to a playback duration of from 2 to 10 seconds, but the duration over which the packets are received will generally be substantially less than the playback duration of the program content.

The IP client loads the IP packets into a cache memory 56A, which is organized as a circular buffer. Two such memories 56A, 56B are shown in FIG. 2. A service selector 58 operating in response to the user control 54 selects the output of the memory 56A and supplies the packets to suitable decryption and decoding processes (not separately shown), which provide a signal conveying the AV content to the TV appliance 50.

A service predictor 60 that is connected to the IP client makes an intelligent prediction regarding the user's next channel change request and the IP client responds to the prediction by transmitting an HTTP Get command to the HTTP server that is identified in the service prediction. Generally, this will be a different server (e.g. the server of the ABR streaming appliance 20) but it may be the same HTTP server as the server providing the current service if the HTTP server 18 supports multiple services. The IP client pulls the manifest file for the predicted service from the HTTP server, selects a version of the program content for the predicted service and pulls at least one segment of the program content from the server. In order to avoid network congestion the IP client will generally select the lowest bit rate version. The IP client 52 loads the IP packets for the predicted service into the cache memory 56B. As time passes, and provided there has been no change in the prediction, segments of the predicted service, stored in the cache memory 56B, are overwritten by new segments pulled from the HTTP server. Should the customer request a change to the channel provided by the predicted service, the user control 54 can immediately cause the service selector 58 to select the output of the cache memory 56B so that the packets for the new selected service are available for decryption and decoding without having to wait for the IP client to transmit an HTTP Get command to the HTTP server, receive the manifest file, and pull a version of the program content from the server. As segments of the new selected service are received, they overwrite segments that were previously received.

The IP client 52 recognizes that the selected service has changed and accordingly gives priority to the new selected service in selecting the version of that service to pull from the appropriate HTTP server. Thus, if the client pulled a lower bit rate version from the server while the service was a predicted service, it may pull a higher bit rate version when the service is the selected service. The first segment at the higher bit rate immediately follows the last segment at the lower bit rate in playback order but there is no discontinuity in evolution of content, only a change in resolution. Even though the resolution changes, the content flows smoothly.

When the selected service changes, the service predictor identifies a new predicted service to the IP client 52 and the IP client transmits an HTTP Get command to the server that provides the new predicted service. Similarly to the discussion above, the IP client pulls the manifest file for the new predicted service, selects a version of the program content for that service, pulls the segments of the selected version from the server, and loads the IP packets into the circular buffer 56A. The selected version will normally be a lower bit rate version. It will be appreciated that the new predicted service could be the previous selected service.

The service predictor 60 identifies the predicted service using one or more algorithms. For example, if the service predictor detects that the user is selecting services in a sequence of monotonically increasing or decreasing channel numbers (i.e. channel surfing), the service predictor will generally identify as the predicted service the service that conveys the next channel number in the sequence. Alternatively, the user might select services based on a list or menu of favorite channels, in which case the service predictor may identify the service that convey the channel that is next in the sequence of favorites, in the order being traversed by the user. A third possibility would be for the algorithm to learn a particular viewer's channel changing habits in real time. For example, the user might be switching repeatedly between the services providing two sports channels, in which case the service predictor may identify the service that provides the channel that is not currently being viewed.

It will be appreciated that the memory of the STB could be configured to provide more than two circular buffers, in which case the STB would support a service predictor that identifies two or more services. Although it is only necessary that the circular buffers should hold a small number of segments of the program content for the predicted service, if the circular buffers are large enough to hold several minutes of the program content for the predicted service the customer may be able to view the program content starting from an effective time before the real time at which the customer requests a channel change, allowing a degree of time shifting.

The IP client may run not only on an STB, as discussed, but also on a tablet or phone that is connected to the internet, either through a home gateway, as described in connection with FIGS. 1 and 2, or through other network infrastructure such as the cellular telephone network infrastructure.

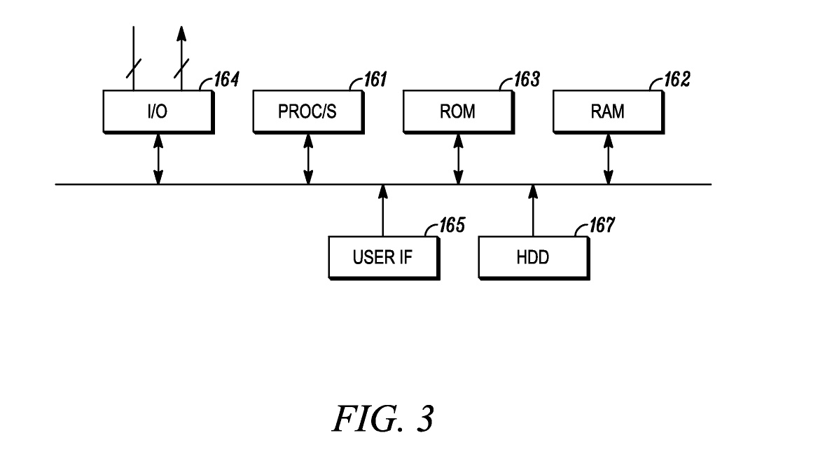

Referring to FIG. 3, one or more of the functional blocks shown in FIG. 2 for receiving the IP packets from the home gateway 42 and producing the signal for driving the TV appliance 50 may be implemented by a computing device comprising at least one processor 161, random access memory 162, read only memory 163, I/O devices 164 (including suitable adaptors for receiving and transmitting bitstreams), a user interface 165, a hard disk drive 167 and one or more buses, configured in a generally conventional architecture. The computing device operates in accordance with a program that is stored in a non-transitory computer readable memory, such as the hard disk drive 167, and is loaded into the random access memory 162 for execution. The program is composed of instructions such that when the computing device receives a signal representing the input of the STB 46, by way of a suitable interface included in the I/O devices, the computing device allocates memory to appropriate buffers and utilizes other suitable resources and functions to perform the various operations that are described above as being performed by the functional blocks of the STB.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of operating an adaptive bit rate streaming internet protocol (IP) client device that is connected to a display device for presentation of audio/video (AV) content, the method comprising:
receiving a manifest file associated with a linearly available user-selected service, the manifest file including meta data for a plurality of bitrate versions that are available for a first AV content for the user-selected service;
selecting a bitrate version of the first AV content for playback at the display device;
pulling segments of the selected bitrate version of the first AV content identified in the manifest file for the user-selected service from a server;
presenting the segments of the first AV content to the display device;
performing a prediction analysis to predict one or more unselected services likely to be selected for presentation at the display device;
receiving a manifest file associated with a predicted AV content associated with the one or more unselected services, the manifest file including meta data for a plurality of bitrate versions that are available for the predicted AV content;
while presenting the segments of the first AV content to the user, concurrently pulling segments of a selected version of the predicted AV content for at least one of the one or more unselected services from a server that hosts multiple versions of the predicted AV content and temporarily storing the selected version of the predicted AV content for the at least one of the one or more unselected services in a memory local to the IP client device; and
in response to a request for presentation of the predicted AV content for the additional service, reading the selected version of the predicted AV content directly from the memory local to the IP client device without having to wait for an additional request to the server for the manifest file associated with the now selected predicted AV content, and presenting the locally stored segments of the first predicted AV content to the display device.

2. A method according to claim 1, further comprising subsequently continuing to pull segments of the predicted AV content and temporarily storing a version of the predicted AV content in memory while overwriting content previously stored in the memory.

3. A method according to claim 1, wherein the server hosts multiple versions of an available AV content, hosting at least a first version and a second version, the second version providing the available AV content at a higher bit rate than the first service,
wherein the method further comprises initially pulling the first version of the predicted AV content from the server and, subsequent to said request, pulling the second version of the predicted AV content from the server.

4. (canceled)

5. A method according to claim 1, comprising prior to the step of concurrently pulling said selected version of AV content for said at least one of the one or more unselected services, selecting said at least one of the one or more unselected services based on a history of services previously presented to the user.

6. A method according to claim 1, comprising prior to the step of concurrently pulling said selected version of AV content for said at least one of the one or more unselected services, selecting said at least one of the one or more unselected services based on a menu of favorite services previously created by the user.

7. A method of operating an adaptive bit rate streaming internet protocol (IP) client device that is connected to a display device for presentation of audio/video (AV) content, the method comprising:
receiving a manifest file associated with a linearly available user-selected service, the manifest file including meta data for a plurality of bitrate versions that are available for a first coded AV content for the user-selected service;
selecting a bitrate version of the first coded AV content for playback at the display device;
pulling segments of the selected bitrate version of the first coded AV content identified in the manifest file for the user-selected service from an adaptive bit rate server, decoding the AV content for the user-selected service, and presenting the segments of the first decoded AV content to the display device,
performing a prediction analysis to predict one or more unselected services likely to be selected for presentation at the display device;
receiving a manifest file associated with a predicted AV content associated with the one or more unselected services, the manifest file including meta data for a plurality of bitrate versions that are available for the predicted AV content;
while presenting the segments of the first coded AV content to the user, concurrently pulling a segments of selected version of the predicted coded AV content for at least one of the one or more unselected services from a server that hosts multiple versions of the predicted AV content, and temporarily storing the selected version of the predicted coded AV content for the at least one of the one or more unselected services in a memory local to the IP client device, and
in response to a request for presentation of the predicted AV content for the additional service, reading the selected version of the predicted coded AV content for the at least one of the one or more unselected services directly from the memory local to the IP client device without having to wait for an additional request to the server for the manifest file associated with the predicted AV content, decoding the locally stored segments of the first predicted AV content, and presenting the decoded AV content for the additional service to the display device.
